(19) United States
(12) Patent Application Publication
(10) Pub. No.: US 2025/0309575 A1
(43) Pub. Date: Oct. 2, 2025

(54) TERMINAL MATERIAL AND ELECTRICAL CONNECTION TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Ryota MIZUTANI, Mie (JP); Toshiro SAKAI, Mie (JP)

(21) Appl. No.: 19/082,829

(22) Filed: Mar. 18, 2025

(30) Foreign Application Priority Data
Mar. 29, 2024 (JP) 2024-056891

(51) Int. Cl. H01R 13/03

(52) U.S. Cl. CPC H01R 13/03

(57) ABSTRACT

A terminal material 1 includes a base material 11, an intermediate layer 14 made of Ag or Ag alloy and covering a surface of the base material, and a surface layer 15 containing Ag and at least one of a sulfur-containing organic compound and a carbon material and configured to contact and cover a surface of the intermediate layer 14. The intermediate layer 14 has a higher Ag purity than the surface layer 15. The surface layer 15 has a surface roughness Rz less than 1.2 μm. Further, an electrical connection terminal is configured to contain the terminal material 1, and the intermediate layer 14 and the surface layer 15 are formed on the surface of the base material 11 at least in an electrical contact point to be held in contact with a mating electrically conductive member.

### CROSS-REFERENCE TO RELATED APPLICATIONS

This application is based on and claims priority from Japanese Patent Application No. 2024-056891, filed on Mar. 29, 2024, with the Japan Patent Office, the disclosure of which is incorporated herein in its entirety by reference.

### TECHNICAL FIELD

The present disclosure relates to a terminal material and an electrical connection terminal.

### BACKGROUND

In an automotive vehicle, an electrical connection terminal having an Ag coating layer provided on a surface may be used as an electrical connection terminal for large current or the like. The terminal having the Ag coating layer provided on the surface is excellent in heat resistance, corrosion resistance and electrical conductivity, whereas the surface is easily worn when being subjected to sliding because Ag is soft and has a property of causing easy adhesion. Accordingly, the hardness of the Ag coating layer may be enhanced to form a hard silver layer by containing an additive element such as Se in the Ag coating layer as one means for suppressing wear while using excellent properties of Ag such as heat resistance and electrical conductivity.

However, even if the Ag coating layer on the surface of the terminal is formed into the hard silver layer by containing the additive element such as Se, it may not be possible to sufficiently improve wear resistance. For example, as a larger current flows in a terminal, a higher contact load needs to be applied to an electrical contact point. In the case of causing the electrical contact point to slide by applying a high contact load in that way, required wear resistance may not be sufficiently satisfied with a conventional general hard silver layer. In such a case, it is considered to apply an Ag coating layer better in wear resistance than the conventional general hard silver layer as an Ag coating layer provided on a surface of the terminal. For example, it is disclosed in Japanese Patent Laid-open Publication No. 2022-048977 to manufacture a silver plating material by forming a surface layer made of silver on a material, using a silver plating solution containing benzothiazoles or derivatives thereof. It is described that a silver plating material better in wear resistance than before is obtained in this way. Further, a metal component including a base plate covered by an Ag-graphene composite plating film is disclosed in Japanese Patent Laid-open Publication No. 2022-170877, and graphene diffused in the Ag-graphene composite plating film has specific size, content and arrangement direction. It is described to combine an improvement in electrical conductivity and an improvement in wear resistance for the silver plating film in this way.

### SUMMARY

As disclosed in Japanese Patent Laid-open Publication Nos. 2022-048977 and 2022-170877, wear resistance can be improved by adding an organic compound or an additive made of a carbon material such as graphene to the Ag coating layer provided in the electrical connection terminal. However, the electrical connection terminal including the Ag coating layer is desired to further improve wear resistance and reduce a friction coefficient of the surface from the perspective of reducing an insertion force required in fitting and connecting the electrical connection terminal to a mating electrical connection terminal and extending a life of the electrical connection terminal.

In view of the above, it is aimed to provide a terminal material and an electrical connection terminal reduced in contact resistance on a surface of an Ag coating layer and improved in wear resistance.

A terminal material of the present disclosure is provided with a base material, an intermediate layer made of Ag or Ag alloy, the intermediate layer covering a surface of the base material, and a surface layer containing Ag and at least one of a sulfur-containing organic compound and a carbon material, the surface layer contacting a surface of the intermediate layer and covering the surface of the intermediate layer, the intermediate layer having a higher Ag purity than the surface layer, and the surface layer having a surface roughness Rz less than 1.2 μm.

An electrical connection terminal of the present disclosure is configured to contain the terminal material, and the intermediate layer and the surface layer are formed on the surface of the base material at least in an electrical contact point to be held in contact with a mating electrically conductive member.

The terminal material and the electrical connection terminal of the present disclosure are reduced in contact resistance on the surface of the Ag coating layer and improved in wear resistance.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a section schematically showing the configuration of a terminal material according to one embodiment of the present disclosure.

FIG. 2 is a perspective view showing the structure of an electrical connection terminal according to one embodiment of the present disclosure.

FIGS. 3A and 3B show electronic microscope images obtained by observing a cross-section of the terminal material, wherein FIG. 3A shows a low magnification image and FIG. 3B shows a high magnification image obtained by enlarging and observing the vicinity of an intermediate layer of FIG. 3A.

FIG. 4 is a table showing evaluation results on surface roughness, friction coefficient and wear resistance for a plurality of samples having different intermediate layer thicknesses.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are described.
[1] The terminal material of the present disclosure is provided with a base material, an intermediate layer made of Ag or Ag alloy, the intermediate layer covering a surface of the base material, and a surface layer containing Ag and at least one of a sulfur-containing organic compound and a carbon material, the surface layer contacting a surface of the intermediate layer and covering the surface of the intermediate layer, the intermediate layer having a higher Ag purity than the surface layer, and the surface layer having a surface roughness Rz less than 1.2 μm.

In the terminal material, the surface layer containing Ag contains at least one of the sulfur-containing organic compound and the carbon material as an additive. Thus, the surface layer has a high wear resistance. Particularly, since the surface roughness Rz of the surface layer is less than 1.2 μm, a friction coefficient on the surface of the surface layer is suppressed to be small. Further, the wear resistance is effectively enhanced and the surface layer is hardly worn even after friction. Further, in the terminal material, the intermediate layer having a higher Ag purity than the surface layer is formed below the surface layer. This intermediate layer contributes to a reduction in the surface roughness of the surface layer.
[2] In the terminal material of [1] described above, a thickness of the intermediate layer may be 1.0 μm or more. Then, a particularly high effect of reducing the surface roughness on the surface layer and reducing a friction coefficient and improving wear resistance caused by the reduced surface roughness is obtained.
[3] In the terminal material of [1] or [2] described above, the terminal material may be further provided with a strike layer having a smaller thickness than the intermediate layer between the base material and the intermediate layer, and the intermediate layer may be in contact with a surface of the strike layer. The strike layer has an effect of enhancing adhesion between the intermediate layer and the surface layer to the base material. An improvement in the adhesion of the surface layer also leads to a further reduction in the surface roughness on the surface layer.
[4] In the terminal material of any one of [1] to [3] described above, the terminal material may be further provided with an underlayer in contact with the surface of the base material and made of Ni or Ni alloy between the base material and the intermediate layer. A material in which the underlayer made of Ni or Ni alloy is provided on the surface of Cu or the Cu base material is generally used as the base material of the terminal material. By forming the surface layer after forming the intermediate layer on the surface of the base material, the terminal material excellent in the adhesion of those layers to the base material can be formed. An improvement in adhesion also leads to a reduction in the surface roughness on the surface layer.
[5] The electrical connection terminal of the present disclosure is configured to contain the terminal material of any one of [1] to [4] described above, and the intermediate layer and the surface layer are formed on the surface of the base material at least in an electrical contact point to be held in contact with a mating electrically conductive member. This electrical connection terminal is configured to contain the terminal material having a friction coefficient on the surface of the surface layer suppressed to be low and enhanced in wear resistance, whereby a low friction coefficient and a high wear resistance can be utilized at the electrical contact point. As a result, an insertion force required to connect the electrical connection terminal to a mating electrical connection terminal can be suppressed to be small and a long life can be expected.

### Details of Embodiment of Present Disclosure

Hereinafter, an embodiment of the present disclosure is described in detail using the drawings.

### Terminal Material

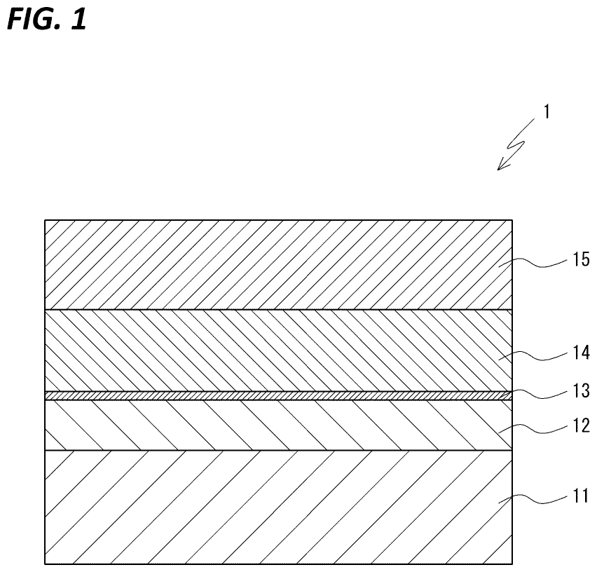

A terminal material according to the embodiment of the present disclosure is described below. A cross-section of a terminal material 1 according to one embodiment of the present disclosure is schematically shown in FIG. 1.

### Summary of Configuration of Terminal Material

The terminal material 1 includes a base material 11 and a plurality of metal coating layers covering a surface of the base material 11. An underlayer 12, a strike layer 13, an intermediate layer 14 and a surface layer 15 are provided from the side of the base material 11 as the coating layers. Out of these, the underlayer 12 and the strike layer 13 are arbitrarily provided. Each of the strike layer 13, the intermediate layer 14 and the surface layer 15 is configured as a layer mainly containing Ag (layer containing 50% by mass or more of Ag).

The base material 11 is configured as a metal plate material. The type of metal constituting the base material 11 is not particularly limited, and various metal materials generally applicable as base materials of electrical connection members including a terminal can be used. Preferably, the base material 11 may be made of Cu or Cu alloy generally used as a base material of terminals.

The underlayer 12 is an arbitrarily provided layer. If the base material 11 is made of Cu or Cu alloy, it is preferred to provide the underlayer 12 made of Ni or Ni alloy in contact with the surface of the base material 11. Then, the underlayer 12 functions to enhance the adhesion of the strike layer 13, the intermediate layer 14 and the surface layer 15 to the base material 11. By enhancing the adhesion of the intermediate layer 14 and the surface layer 15, an effect of smoothing the surface of the surface layer 15 to be described later is obtained. In addition, the underlayer 12 functions to suppress the diffusion of constituent elements of the base material 11 such as Cu to the strike layer 13, the intermediate layer 14 and the surface layer 15. If the constituent elements of the base material 11 are diffused to those upper layers and reach the surface of the surface layer 15, there is a possibility that the constituent elements are oxidized to increase the contact resistance of the surface layer 15. A thickness of the underlayer 12 can be, for example, within a range of 0.5 μm or more and 10 μm or less.

The strike layer 13 is a layer arbitrarily provided to appropriately cover the surface of the base material 11 via the underlayer 12. The strike layer 13 is made of Ag or Ag alloy and has a higher Ag purity than the surface layer 15. Preferably, the strike layer 13 may have an Ag purity of 99.0% by mass or more, further 99.5% by mass or more. The strike layer 13 may contain only Ag and unavoidable impurities, but may contain an additive element having an action of hardening an Ag layer in addition to Ag and the unavoidable impurities. Se, Sb, C, N, S and the like can be cited as additive elements of that type.

A thickness of the strike layer 13 is smaller than that of the intermediate layer 14. A specific thickness of the strike layer 13 is not particularly limited, but can be, for example, within a range of 0.01 μm or more and 0.1 μm or less. The strike layer 13 functions to enhance the adhesion of the intermediate layer 14 and the surface layer 15 to the base material 11 and the underlayer 12. Particularly, in the case of providing the strike layer 13 on the surface of the underlayer 12 made of Ni or Ni alloy, the strike layer 13 is formed in close contact with the surface of the underlayer 12 while reducing Ni oxides on the surface of the underlayer 12. By enhancing the adhesion of the intermediate layer 14 and the surface layer 15 to the base material 11 and the underlayer 12, the effect of smoothing the surface of the surface layer 15 to be described later is also obtained.

The intermediate layer 14 is a layer provided to cover the surface of the base material 11. If the terminal material 1 includes the underlayer 12 and/or the strike layer 13, the intermediate layer 14 is provided to cover the surface of one of those layers. Particularly, if the terminal material 1 includes the strike layer 13, the intermediate layer 14 is provided in contact with the surface of the strike layer 13. The intermediate layer 14 is made of Ag or Ag alloy and has a higher Ag purity than the surface layer 15. Similarly to the strike layer 13, the intermediate layer 14 may also have an Ag purity of 99.0% by mass or more, further 99.5% by mass or more. The intermediate layer 14 may contain only Ag and unavoidable impurities, but may contain an additive element having an action of hardening an Ag layer in addition to Ag and the unavoidable impurities. Se, Sb, C, N, S and the like can be cited as additive elements of that type.

A thickness of the intermediate layer 14 is not particularly limited, but is preferably 1.0 μm or more. Further, this thickness may be roughly 10 μm or less or 5.0 μm or less. Although described in detail later, the surface roughness of the surface layer 15 can be reduced by providing the intermediate layer 14. Further, the corrosion of the terminal material 1 can be suppressed and the corrosion resistance of the terminal material 1 can be enhanced by providing the intermediate layer 14.

The surface layer 15 is a layer provided to cover the surface of the intermediate layer 14. The surface layer 15 contains Ag and an additive. The additive contains at least one of a sulfur-containing organic compound and a carbon material. The type of the sulfur-containing organic compound is not particularly limited, but preferred examples include benzothiazoles, thiols, sulfides, disulfides, sulfur-containing polymers including sulfonated anionic polymers and derivates of those. Only one type of sulfur-containing organic compound may be used or two or more types of sulfur-containing organic compounds may be used in combination. The type of the carbon material is also not particularly limited, and graphite, graphene, carbon fibers, fullerenes, carbon nanotubes and the like can be used. The use of graphite is particularly preferable. Only one type of carbon material may be used or two or more types of carbon materials may be used in combination. The surface layer 15 is preferably made of only Ag and the additive except unavoidable impurities, but a metal element other than Ag may be contained if a content thereof is less than that of Ag. Although described in detail later, a surface roughness Rz is less than 1.2 μm in the surface layer 15. Since having such a highly smooth surface, the surface layer 15 has a low friction coefficient and a high wear resistance.

In the terminal material 1 according to this embodiment, the intermediate layer 14 and the surface layer 15 are formed on the surface of the base material 11 in this order. If the intermediate layer 14 and the surface layer 15 are directly in contact with each other, the other layers including the underlayer 12 and the strike layer 13 may be provided. The surface layer 15 is preferably exposed on the outermost surface of the terminal material 1, but a thin film (not shown) such as an organic layer may be provided on the surface of the surface layer 15 as long as the thin film does not significantly affect properties of the surface layer 15.

### Details of Surface Layer

In the surface layer 15, the sulfur-containing organic compound and the carbon material function to improve the wear resistance of the surface layer 15. That is, when an electrical contact point made of the terminal material 1 according to this embodiment is brought into contact with and slid against another electrical contact point (including the one made of the terminal material 1), the occurrence of adhesion between the both electrical contact points is suppressed. Further, the surface layer 15 contributes to keeping a friction coefficient between the both electrical contact points low. An effect of improving the wear resistance and reducing the friction coefficient is mainly brought about by an improvement in the hardness of the surface layer 15 due to the micronization of Ag crystals and a reduction in Ag concentration in the surface layer 15. The sulfur-containing organic compound and the carbon material can be contained in the surface layer 15 by being added to a plating solution when the surface layer 15 is formed by a plating method. The sulfur-containing organic compound and the carbon material contained in the surface layer 15 in that way maintain the molecular structure of the sulfur-containing organic compound and the skeletal structure of the carbon material even in the surface layer 15 in many cases. Even if the molecular structure of the sulfur-containing organic compound and the skeletal structure of the carbon material are at least partially changed or lost, the sulfur-containing organic compound and the carbon material are assumed to be respectively contained in the surface layer 15.

A content of the additive in the surface layer 15 is not particularly limited, but may be so set that the Ag purity in the surface layer 15 is 99.5% by mass or less, further 99.4% by mass or less. Further, if the additive is made of the sulfur-containing organic compound, the Ag purity may be 99.0% by mass or less, further 98.5% by mass or less. Then, a high effect of improving the wear resistance and reducing the friction coefficient is obtained by containing a sufficient amount of the additive in the surface layer 15. On the other hand, the Ag purity in the surface layer 15 is preferably 97.0% by mass or more, further 98.0% by mass or more. Further, if the additive is made of the carbon material, the Ag purity may be 99.0% by mass or more. Then, properties exhibited by Ag such as heat resistance, corrosion resistance and electrical conductivity can be sufficiently utilized as the properties of the surface layer 15.

In the surface layer 15, the surface roughness Rz (maximum height) is less than 1.2 μm. Since having such a highly smooth surface, the surface layer 15 is particularly excellent in reducing the friction coefficient of the surface and improving the wear resistance. The surface roughness Rz is more preferably 1.1 μm or less, further 1.0 μm or less. The smaller the surface roughness Rz, the more preferable. A lower limit of the surface roughness Rz is not particularly determined, but the surface roughness Rz in an actual Ag coating layer is roughly 0.5 μm or more. A reduction in the surface roughness Rz of the surface layer 15 can be, for example, achieved by providing the intermediate layer 14 below the surface layer 15 and further forming the intermediate layer 14 to be thick. This can also be achieved by a reduction in current density, an increase in metal ion concentration in the plating solution, an increase in plating solution temperature, an increase in plating solution stirring amount and the addition of a brightener as plating conditions in forming the surface layer 15 by the plating method.

A thickness of the surface layer 15 is not particularly limited, but can be, for example, 0.5 μm or more and 10 μm or less. By forming the surface layer 15 to have a thickness of 0.5 μm or more, a large effect of reducing the friction coefficient and improving the wear resistance is obtained, utilizing the properties of the constituent material of the surface layer 15. The thickness of the surface layer 15 is more preferably 1.0 μm or more. On the other hand, by suppressing the thickness of the surface layer 15 to 10 μm or less, surface smoothness is easily enhanced, an effect brought about by providing the intermediate layer 14 largely acts and the effect of reducing the friction coefficient and improving the wear resistance is easily enhanced. The thickness of the surface layer 15 is more preferably 5.0 μm or less.

By reducing the friction coefficient of the surface of the surface layer 15, a force required for sliding can be suppressed to be small when the surface of the terminal material 1 is brought into contact with and slid against another body. For example, when the electrical connection terminal is made of the terminal material 1 and that electrical connection terminal is fit and connected to a mating electrical connection terminal, accompanied by sliding between electrical contact points, an insertion force required for connection can be suppressed to be small. The friction coefficient can be suppressed to 0.5 or less, for example, under measurement conditions shown in Examples. Further, by improving the wear resistance of the surface of the surface layer 15, the surface of the terminal material 1 is hardly worn, accompanied by adhesion, even if the surface of the terminal material 1 is brought into contact with and slid against another body. As a result, a high durability of the terminal material 1 can be maintained even in a use environment accompanied by sliding. For example, even if the electrical connection terminal made of the terminal material 1 is used while being repeatedly inserted into and withdrawn from the mating electrical connection terminal, a state where the surface layer 15 is exposed on the surface of the electrical contact point can be maintained over a long period of time.

### Details of Intermediate Layer

In the terminal material 1 according to this embodiment, smoothness is easily enhanced and the surface roughness is easily reduced in the surface of the surface layer 15 by providing the intermediate layer 14 below the surface layer 15. This is because the intermediate layer 14 acts to fill up and smooth irregularities of the lower layer. As described above, a high effect of reducing the friction coefficient and improving the wear resistance in the surface of the surface layer 15 is obtained by reducing the surface roughness on the surface of the surface layer 15. That effect is higher as the thickness of the intermediate layer 14 is increased. Thus, the thickness of the intermediate layer 14 is preferably set to 1.0 μm or more. More preferably, the thickness of the intermediate layer 14 may be set to 2.0 μm or more, further 3.0 μm or more.

The intermediate layer 14 also has an effect of suppressing the corrosion of the terminal material 1 in addition to an effect of smoothing the surface of the surface layer 15. The surface layer 15 has a high wear resistance by containing the additives made of at least one of the sulfur-containing organic compound and the carbon material. By containing these additives, the Ag purity is reduced, whereby the terminal material 1 easily undergoes corrosion as compared to the case where the additives are not contained. However, the corrosion of the terminal material 1 is suppressed by providing the intermediate layer 14 below the surface layer 15. Particularly, if the thickness of the intermediate layer 14 is 1.0 μm or more, the corrosion of the terminal material 1 can be effectively suppressed for liquid corrosive substances. On the other hand, if the thickness of the intermediate layer 14 is 3.0 μm or less, the corrosion of the terminal material 1 can be effectively suppressed for gas corrosive substances.

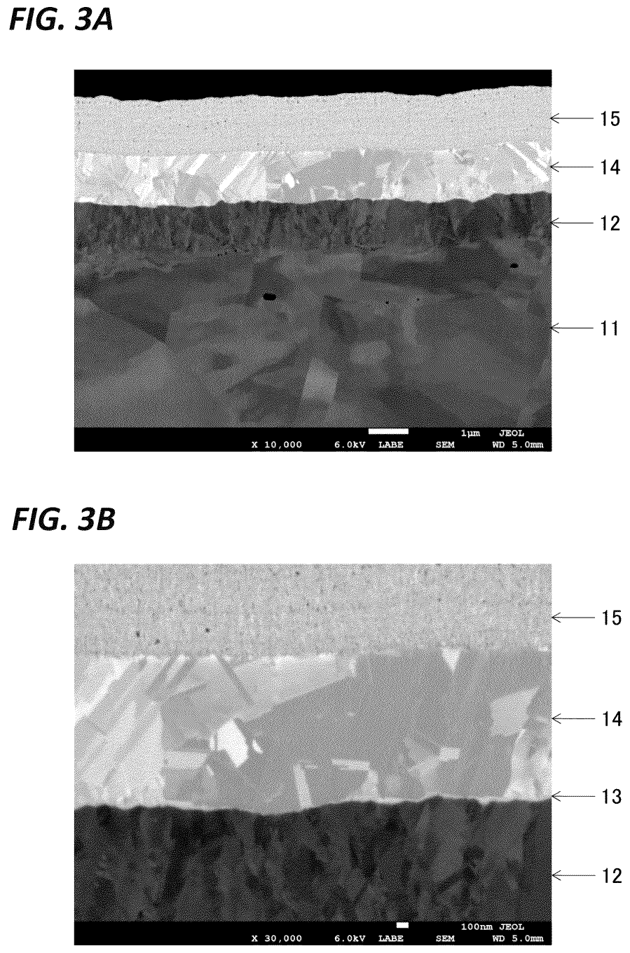

If the terminal material 1 includes the strike layer 13, both the intermediate layer 14 and the strike layer 13 may be configured as layers of Ag or Ag alloy having a higher Ag purity than the surface layer 15 and may have the same component composition. However, the intermediate layer 14 and the strike layer 13 are independently formed by individual plating steps or the like. That is, after the strike layer 13 is formed first, the intermediate layer 14 is formed on the surface of the strike layer 13. Thus, as also shown in FIG. 3B, the presence of a clear interface can be confirmed on a boundary between the strike layer 13 and the intermediate layer 14 by electron microscopy. The strike layer 13 is a thin layer formed to enhance adhesion between the upper and lower layers and formed at a low speed, using a plating solution having a low Ag concentration to enhance the function thereof. In contrast, the intermediate layer 14 is suitably formed at a relatively high speed to ensure a certain thickness. The structure of the strike layer 13 and that of the intermediate layer 14 differ due to those plating condition differences in many cases.

As also shown in FIGS. 3A and 3B, the intermediate layer 14 is configured by a structure including relatively large crystal grains, whereas the strike layer 13 hardly forms large crystal grains. Thus, an average grain diameter of the crystal grains constituting the intermediate layer 14 tends to be larger than that of the crystal grains constituting the strike layer 13. The strike layer 13 not forming crystal grains of a size recognizable by an electron microscope is also included in this form. Further, the average grain diameter of the crystal grains of the intermediate layer 14 tends to be larger than the thickness of the strike layer 13. The average grain diameter of the crystal grains of the intermediate layer 14 is not particularly limited, but can be, for example, within a range of 0.1 μm or more and 0.5 μm or less. The average grain diameter of the crystal grains of the strike layer 13 can be, for example, 0.1 μm or less.

However, the clear interface may not be formed between the strike layer 13 and the intermediate layer 14, depending on formation conditions and the like of the strike layer 13 and the intermediate layer 14. Even in such a case, if a thickness of a region equivalent to the intermediate layer 14 is 1.0 μm or more, out of a region corresponding to a combined region of the strike layer 13 and the intermediate layer 14 and having a higher Ag purity than the surface layer 15, a high effect of smoothing the surface of the surface layer 15 by the intermediate layer 14 can be obtained. As described above, since the thickness of the strike layer 13 is preferably 0.1 μm or less, the thickness of the region corresponding to the combined region of the strike layer 13 and the intermediate layer 14 and having a higher Ag purity than the surface layer 15 is preferably 1.1 μm or more.

### Electrical Connection Terminal

The electrical connection terminal according to one embodiment of the present disclosure is configured to contain the terminal material 1 according to the embodiment of the present disclosure described above. In the electrical connection terminal, a laminated structure of the intermediate layer 14 and the surface layer 15 is formed at least in an electrical contact point to be brought into contact with a mating electrically conductive member such as a mating electrical connection terminal. If being formed at least in the electrical contact point, the intermediate layer 14 and the surface layer 15 (and the underlayer 12 and the strike layer 13) may be formed in the entire surface region of the electrical connection terminal or may be formed only in a partial region including the electrical contact point.

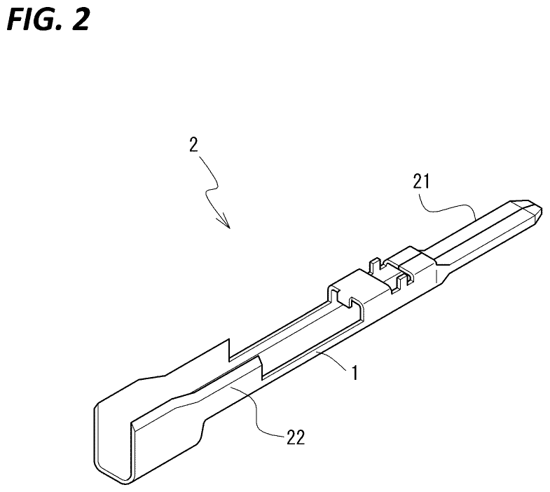

The specific type and shape of the electrical connection terminal are not particularly limited, but a case where the electrical connection terminal is a fitting-type male terminal 2 is illustrated in FIG. 2. The male terminal 2 has a shape similar to that of a known fitting-type male terminal. That is, the male terminal 2 includes a terminal connecting portion 21 on a front side and a wire connecting portion 22 on a rear side. The terminal connecting portion 21 is a part to be electrically connected to a mating female terminal and has a tab-like structure in the form of a flat plate. The male terminal 2 and the female terminal are fit and connected by inserting the terminal connecting portion 21 of the male terminal 2 into a box-shaped terminal connecting portion of the female terminal with a tip side in the lead. In the male terminal 2, a wire is electrically and physically connected to the wire connecting portion 22. In the male terminal 2, the intermediate layer 14 and the surface layer 15 are appropriately formed together with the underlayer 12 and the strike layer 13 in the surface of the terminal connecting portion 21. Preferably, the entire male terminal 2 is made of the terminal material 1 including those coating layers.

In this structure, the surface layer 15 is exposed on the outermost surface of the terminal connecting portion 21 of the male terminal 2. Due to a reduction in the friction coefficient of the surface of the surface layer 15, a force required for sliding is suppressed to be small in a contact portion between the male terminal 2 and the female terminal when the terminal connecting portion 21 of the male terminal 2 is inserted into the box-shaped terminal connecting portion of the female terminal, accompanied by sliding, to form an electrical connection. That is, an insertion force required to insert the male terminal 2 is suppressed to be small. Further, due to a high wear resistance of the surface of the surface layer 15, wear accompanied by Ag adhesion hardly occurs in the contact portion between the male terminal 2 and the female terminal even if sliding is repeated. By suppressing wear, a state where the male terminal 2 and the female terminal are in contact via the surface layer 15 is maintained over a long period of time and the durability of the male terminal 2 is enhanced. Further, due to the presence of the intermediate layer 14, a good electrical connection is formed and maintained between the male terminal 2 and the female terminal, coupled with an effect brought about by the high durability, by maintaining a low contact resistance of the terminal material 1 even in a corrosive environment. Note that the mating female terminal may be made of the terminal material 1 according to the embodiment of the present disclosure including the above respective coating layers, similarly to the male terminal 2, or may be made of another metal material. A material in which an Ag layer having a high purity like the intermediate layer 14 is formed to be exposed on an outermost surface can be cited as an example of the other metal material.

### Examples

Examples are described below. Note that the present invention is not limited by these Examples. Here, the influences of an intermediate layer on friction properties of a surface layer were verified. Unless otherwise specified, samples were fabricated and evaluated at a room temperature in the atmosphere.

### Fabrication of Samples

A Ni layer having a thickness of 1.0 μm was formed as an underlayer on a surface of a clean Cu alloy base material by an electrolytic plating method. Subsequently, an Ag strike layer was formed on the surface of the Ni layer by the electrolytic plating method. The Ag strike layer had a thickness of 0.1 μm or less and an Ag purity of 99.9% by mass. Further, an Ag intermediate layer was formed on the surface of the Ag strike layer by the electrolytic plating method. In each sample, a thickness of the intermediate layer was as shown in Table 1 below.

Subsequently, a surface layer was formed on the surface of the intermediate layer by the electrolytic plating method. At this time, “SILVERON GT-210 Durability Silver” produced by the Du Pont (“SILVERON” is a registered trademark), which is a plating containing a sulfur-containing organic compound, was used as a plating solution. A thickness of the surface layer was 1.0 μm in any of the samples. Plating was performed in a beaker for the samples B to E to form the surface layer by the electrolytic plating method. On the other hand, plating was performed using a hoop plating device for the sample A. Plating in the hoop plating device is characterized by being possible at a high current density as compared to plating in the beaker.

### Evaluation Method

### (1) Confirmation of Laminated Structure

For each sample, a state of a cross-section was observed by a scanning electron microscope (SEM) and the formation of a laminated structure of the underlayer, the strike layer, the intermediate layer and the surface layer was confirmed.

### (2) Confirmation of Component Compositions of Intermediate Layer and Surface Layer

For each sample, the component compositions of the intermediate layer and the surface layer were confirmed. Specifically, element contents in the intermediate layer and the surface layer were respectively analyzed by a glow discharge optical emission spectrometer (GD-OES).

### (3) Measurement of Surface Roughness Rz

For each sample, the surface roughness Rz of the surface layer was measured. Specifically, the surface of each sample was observed through a confocal measurement by a three-dimensional laser microscope. Based on an observed image, the surface roughness was evaluated by a maximum height Rz. The surface roughness Rz was measured at five points on the surface of each sample and an average value of the measured values was recorded.

### (4) Measurement of Friction Coefficient

For each sample, a friction coefficient on the surface of the surface layer was measured. The friction coefficient was measured by bringing an embossed contact point with R of 3.0 mm formed in each sample into contact with and sliding the contact point against each sample in the form of a plate. At the time of the measurement, the embossed contact point was slid on the surface of the plate material with a top part of the embossed contact point held in contact with the surface of the surface layer of the plate material of each sample. At this time, a contact load was set at 5 N and sliding over a distance of 2 mm was repeated back and forth ten times. During sliding, a dynamic friction force acting between the electrical contact points was measured, using a load cell. A value obtained by dividing the dynamic friction force by the load was set as a (dynamic) friction coefficient and recorded in each back-and-forth sliding. If the friction coefficient is suppressed to 0.5 or less while back-and-forth sliding is performed ten times, it can be evaluated that the friction coefficient has been sufficiently reduced.

(5) Evaluation of External Appearance after Sliding

In a friction test for measuring the friction coefficient of (4) described above, the surface of the plate material of each sample was observed by an optical microscope after the embossed contact point was slid back and forth ten times. A state of sliding marks and the presence or absence of exposure of the underlayer were observed. If no sliding mark extending long in a sliding direction is formed and the underlayer is not exposed, the wear resistance of the surface layer can be evaluated to be sufficiently high. For the sample in which the underlayer was not exposed in the friction test for performing back-and-forth sliding ten times with the contact load of 5 N as described above, a friction test in which back-and-forth sliding was performed ten times with a contact load of 7 N as a high load condition was conducted and the presence or absence of exposure of the underlayer was confirmed for a state thereafter.

### Test Results

Analysis results on the component compositions of the surface layer and the intermediate layer are shown together with the manufacturing method of the surface layer and the thicknesses of the surface layer and the intermediate layer for the samples A to E in Table 1 below.

TABLE 1

| Sample Name | | A | B | C | D | E |
|---|---|---|---|---|---|---|
| Surface | Manufacturing Method | HPD* | Beaker | | | |
| Layer | Ag Purity [% by Mass] | 98.3 | 98.1 | 98.2 | 98.3 | 98.3 |
| | C Concentration [% by Mass] | 0.51 | 0.64 | 0.64 | 0.57 | 0.54 |
| | O Concentration [% by Mass] | 0.72 | 0.76 | 0.65 | 0.72 | 0.75 |
| | S Concentration % by Mass] | 0.43 | 0.49 | 0.49 | 0.43 | 0.39 |
| | Thickness [μm] | 1.0 | 1.0 | 1.0 | 1.0 | 1.0 |
| Intermediate | Ag Purity [% by Mass] | 99.9 | 99.9 | 99.9 | 99.9 | 99.9 |
| Layer | Thickness [μm] | 0.2 | 0.2 | 1.0 | 3.0 | 5.0 |

*HPD: Hoop Plating Device

According to Table 1, the intermediate layer is confirmed to have a high Ag purity of 99.9% by mass in any of the samples. The surface layer is formed with a coating layer containing C and S and having a low Ag purity, reflecting the addition of the sulfur-containing organic compound.

FIGS. 3A and 3B show SEM images obtained by observing a cross-section of the sample C. FIG. 3A shows a low magnification image and FIG. 3B shows a high magnification image obtained by enlarging and observing the vicinity of the intermediate layer (14). As shown in FIG. 3A, the lamination of the underlayer (12), the intermediate layer (14) and the surface layer (15) on the surface of the base material (11) is confirmed. Further, according to FIG. 3B, it is confirmed that the thin strike layer (13) is formed between the underlayer (12) and the intermediate layer (14). The intermediate layer is formed with crystal grains having a grain diameter of several 100 nm to several μm. In each sample including the sample C, an average grain diameter of the crystal grains constituting the intermediate layer was 0.14 μm or more and 0.32 μm or less. In contrast, crystal grains having a grain diameter large enough to be confirmable by SEM are not formed in the surface layer and the strike layer present above and below the intermediate layer, and the intermediate layer has a structure clearly distinguishable from the upper and lower layers.

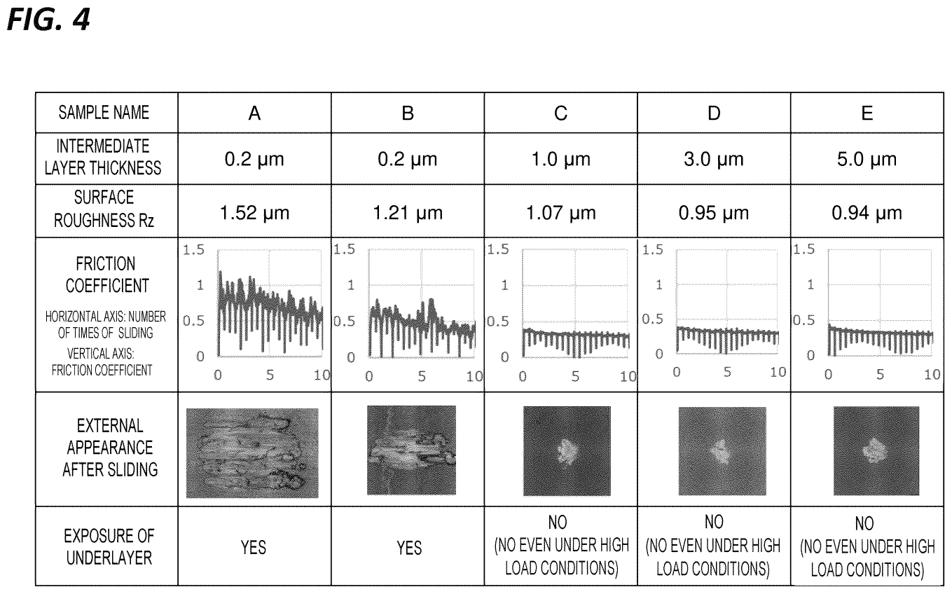

The measurement results on the surface roughness Rz and the friction coefficient, a microscope image showing the external appearance after sliding and the presence or absence of exposure of the underlayer are compiled for each sample in FIG. 4. According to FIG. 4, as the thickness of the intermediate layer increases, the surface roughness Rz decreases and the smoothness of the surface of the surface layer increases. In the samples C to E in which the thickness of the intermediate layer is 1.0 μm or more, the surface roughness Rz is less than 1.2 μm.

The measurement result on the friction coefficients shows that the friction coefficient largely varies during sliding and a measurement value is large in the samples A, B in which the surface roughness Rz is 1.2 μm or more. Both a variation range and the value of the friction coefficient exceed 0.5. Among them, the variation range and the value of the friction coefficient are large in the sample A having a large surface roughness Rz. Contrary to these, the variation range of the friction coefficient is suppressed to be small and the value thereof is also small in any of the samples C to E having the surface roughness Rz less than 1.2 μm. In the entire sliding region, the value of the friction coefficient is 0.5 or less. Except a very early stage of sliding, the variation range is also 0.5 or less.

Next, the external appearance after sliding and the presence or absence of exposure of the underlayer show that the sliding marks are formed to be long in a lateral direction, which is a sliding direction, in the samples A, B having the surface roughness Rz of 1.2 μm or more. Further, color contrast is large in those sliding marks, which indicates the wear of the surface layer. Among them, the sliding marks are formed to take up a large area in the sample A having a large surface roughness Rz. In the samples A, B, the underlayer is exposed. In any of the samples C to E having the surface roughness less than 1.2 μm, sliding marks are formed, but an area thereof is small and the sliding marks do not extend long in the lateral direction, which is the sliding direction. Color contrast in the sliding marks is also suppressed to be small. These indicate that the wear of the surface layer is remarkably suppressed in the samples C to E as compared to the samples A, B. Further, in the samples C to E, the underlayer is not exposed. The underlayer is not exposed even under the higher load condition.

From the above results, it is understood that the surface roughness Rz of the surface layer can be reduced by forming the intermediate layer to be sufficiently thick. By suppressing the surface roughness Rz of the surface layer to be less than 1.2 μm, it is confirmed in the surface layer that the friction coefficient is stabilized at a small value and wear can be suppressed.

Although the embodiment of the present disclosure has been described in detail above, the present invention is not limited to the above embodiment at all and various changes can be made without departing from the gist of the present invention.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A terminal material, comprising:
a base material;
an intermediate layer made of Ag or Ag alloy, the intermediate layer covering a surface of the base material; and
a surface layer containing Ag and at least one of a sulfur-containing organic compound and a carbon material, the surface layer contacting a surface of the intermediate layer and covering the surface of the intermediate layer,
the intermediate layer having a higher Ag purity than the surface layer, and
the surface layer having a surface roughness Rz less than 1.2 μm.

2. The terminal material of claim 1, wherein a thickness of the intermediate layer is 1.0 μm or more.

3. The terminal material of claim 1, further comprising a strike layer having a smaller thickness than the intermediate layer between the base material and the intermediate layer,
wherein the intermediate layer is in contact with a surface of the strike layer.

4. The terminal material of claim 1, wherein:
the base material is made of Cu or Cu alloy, and
the terminal material further comprises an underlayer in contact with the surface of the base material and made of Ni or Ni alloy between the base material and the intermediate layer.

5. An electrical connection terminal configured to contain the terminal material of claim 1, wherein the intermediate layer and the surface layer are formed on the surface of the base material at least in an electrical contact point to be held in contact with a mating electrically conductive member.
